(19) United States
(12) Patent Application Publication
(10) Pub. No.: US 2015/0015836 A1
(43) Pub. Date: Jan. 15, 2015

(54) LIQUID CRYSTAL PANEL AND THE LIQUID CRYSTAL DEVICE WITH THE SAME

(71) Applicant: Shenzhen China Star Optoelectronics Technology Co. Ltd., Shenzhen, Guangdong (CN)

(72) Inventor: Shishuai Huang, Shenzhen City (CN)

(73) Assignee: Shenzhen China Star Optoelectronics Technology Co., Ltd., Shenzhen, Guangdong (CN)

(21) Appl. No.: 14/006,103

(22) PCT Filed: Jul. 18, 2013
(86) PCT No.: PCT/CN2013/079606

§ 371 Date: Feb. 19, 2014

(30) Foreign Application Priority Data
Jul. 15, 2013 (CN) 201310296332.4

(51) Int. Cl. G02F 1/1343

(52) U.S. Cl. CPC G02F 1/134309
USPC 349/106

(57) ABSTRACT

A liquid crystal panel and a liquid crystal display are disclosed. The liquid crystal panel includes an array substrate, a color filtering substrate opposite to the array substrate, and a liquid crystal layer between the array substrate and the color filtering substrate. The array substrate includes scanning lines. The color filtering substrate includes a black matrix (BM) and a common electrode. The scanning lines correspond to the BM. The common electrode covers the BM. The common electrode is provided with a hollow structure corresponding to the scanning lines such that the liquid crystal located corresponding to the locations of the hollow structure are prevented from being twisted when the scanning line applies scanning voltage and the common electrode applies public voltage. In this way, the group of light spots is avoided when the displacement occurs between the array substrate and the color filtering substrate.

### BACKGROUND OF THE INVENTION

1. Field of the Invention

The present disclosure relates to liquid crystal display technology, and more particularly to a liquid crystal panel and a liquid crystal device (LCD) with the same.

2. Discussion of the Related Art

Thin film transistor-liquid crystal display (TFT-LCD) generally includes an array substrate, a color filtering substrate and a liquid crystal layer between the array substrate and the color filtering substrate.

The array substrate includes a plurality of scanning lines extending along a first direction and a plurality of data lines extending along a second direction. The second direction is vertical to the first direction. The scanning lines are spaced apart from each other in the second direction and the data lines are also spaced from each other in the first direction. The scanning lines and the data lines intersect with each other.

The color filtering substrate includes a black matrix (BM), a plurality of RGB photoresists, and a common electrode. The scanning lines of the array substrate correspond to the BM. The common electrode are arranged on a first surface of the color filtering substrate. The first surface faces toward the array substrate. The common electrode covers the BM and the RGB photoresists.

When the grayscale of the LCD is zero, the scanning lines and the corresponding common electrode area on the color filtering substrate form an electrical field. The liquid crystal within the electrical field and in the periphery of the electrical field are twisted such that the lights can pass through the common electrode area If the color filtering substrate faces directly toward the array substrate, the BM blocks the lights. On the other hand, if the alignment between the color filtering substrate and the array substrate is not accurate due to transportation or bending, the BM may be shifted and a group of light spots may occur.

### SUMMARY

The object of the invention is to provide a liquid crystal panel and the LCD with the same to avoid the light leakage when the gray scale is zero.

In one aspect, a liquid crystal panel includes: an array substrate comprising a plurality of scanning lines spaced apart from each other, a plurality of data lines spaced apart from each other, and the data lines intersect with the scanning lines, the scanning line includes a first area and a second area, and wherein the first area intersects with the data lines, and the second area has not interacted with the data lines: a color filtering substrate opposite to the array substrate, and the color filtering substrate includes a black matrix (BM) and a common electrode; a liquid crystal layer between the array substrate and the color filtering substrate; and wherein the scanning line is arranged corresponding to the BM, the common electrode covers the BM, the common electrode includes a hollow structure corresponding to the second area of the scanning line such that liquid crystal located corresponding to the locations of the hollow structure in the liquid crystal layer are prevented from being twisted when the scanning line applies scanning voltage and the common electrode applies public voltage.

Wherein the scanning lines extend along a first direction and the data lines extend along a second direction, the second direction is vertical to the first direction, the scanning lines are spaced apart from each other in the second direction and the data lines are also spaced from each other in the first direction, and a width of the hollow structure in the first direction is larger than or equal to the width of the second area in the first direction.

Wherein the width of the location of the common electrode corresponding to the first area is not larger than the width of the data line in the first direction X.

Wherein the hollow structure is arranged at two lateral sides of the BM.

Wherein a width of the hollow structure is larger than that the width of the BM such that the BM is exposed via the hollow structure.

In another aspect, a liquid crystal and includes: an array substrate comprising a plurality of scanning lines spaced apart from each other; a color filtering substrate opposite to the array substrate, and the color filtering substrate includes a black matrix (BM) and a common electrode; a liquid crystal layer between the array substrate and the color filtering substrate; and wherein the scanning line is arranged corresponding to the BM, the common electrode covers the BM, the common electrode includes a hollow structure such that liquid crystal located corresponding to the locations of the hollow structure in the liquid crystal layer are prevented from being twisted when the scanning line applies scanning voltage and the common electrode applies public voltage.

Wherein the hollow structures are arranged along an extending direction of the scanning lines, and the hollow structures are spaced apart from each other.

Wherein the array substrate further includes a plurality of data lines spaced apart from each other, the data lines intersect with the scanning line, the scanning line includes a first area and a second area, and wherein the first area intersects with the data line, the second area has not interacted with the data line, and the hollow structure corresponds to the second area of the scanning line.

Wherein the scanning lines extend along a first direction and the data lines extend along a second direction, the second direction is vertical to the first direction, the scanning lines are spaced apart from each other in the second direction and the data lines are also spaced from each other in the first direction, and a width of the hollow structure in the first direction is larger than or equal to the width of the second area in the first direction.

Wherein the width of the location of the common electrode corresponding to the first area is not larger than the width of the data line in the first direction X.

Wherein the hollow structure is arranged at two lateral sides of the BM.

Wherein a width of the hollow structure is larger than that of the BM such that the BM is exposed via the hollow structure.

Wherein the hollow structures are consecutively arranged along an extending direction of the scanning line.

Wherein the common electrode is a transparent electrode layer.

In another aspect, a liquid crystal device includes: an array substrate comprising a plurality of scanning lines spaced apart from each other; a color filtering substrate opposite to the array substrate, and the color filtering substrate includes a black matrix (BM) and a common electrode; a liquid crystal layer between the array substrate and the color filtering substrate; and wherein the scanning line is arranged corresponding to the BM, the common electrode covers the BM, the common electrode includes a hollow structure such that liquid crystal located corresponding to the locations of the hollow structure in the liquid crystal layer are prevented from being twisted when the scanning line applies scanning voltage and the common electrode applies public voltage.

Wherein the array substrate further includes a plurality of data lines spaced apart from each other, the data lines intersect with the scanning line, the scanning line includes a first area and a second area, and wherein the first area intersects with the data line, the second area has not interacted with the data line, and the hollow structure corresponds to the second area of the scanning line.

Wherein the scanning lines extends along a first direction and the data lines extends along a second direction, the second direction is vertical to the first direction, the scanning lines are spaced apart from each other in the second direction and the data lines are also spaced from each other in the first direction, and a width of the hollow structure in the first direction is larger than or equal to the width of the second area in the first direction.

Wherein the hollow structure is arranged at two lateral sides of the

Wherein a width of the hollow structure is larger than that of the BM such that the BM is exposed via the hollow structure.

### BRIEF DESCRIPTION OF THE DRAWINGS

FIG. 1 is a cross sectional view of the liquid crystal panel in accordance with a first embodiment.

FIG. 2 is a cross sectional view of the liquid crystal panel of FIG. 1 when the grayscale is zero.

FIG. 3 is a schematic view of the common electrode of the color filtering substrate of the array substrate of FIG. 1.

FIG. 4 is a schematic view of the array substrate of FIG. 1.

FIG. 5 is a cross sectional view of the liquid crystal panel in accordance with a second embodiment.

FIG. 6 is a schematic view of the common electrode of the color filtering substrate of the array substrate of FIG. 5.

FIG. 7 is a schematic view of the common electrode of the color filtering substrate in accordance with a third embodiment.

### DETAILED DESCRIPTION OF THE EMBODIMENTS

Embodiments of the invention will now be described more fully hereinafter with reference to the accompanying drawings, m which embodiments of the invention are shown.

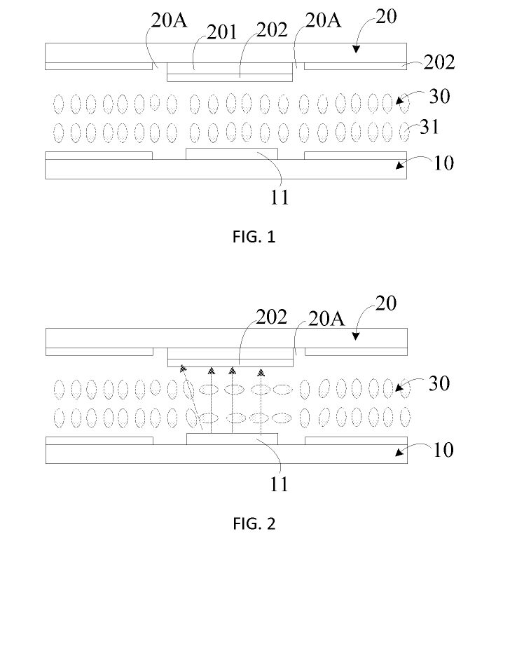

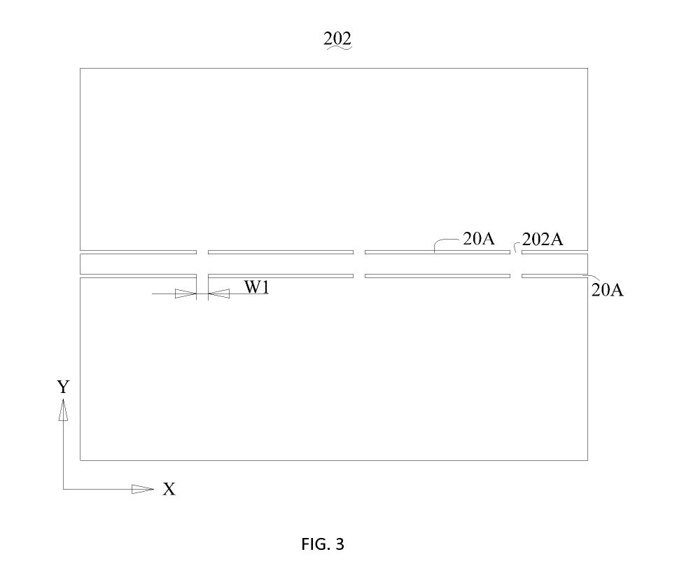

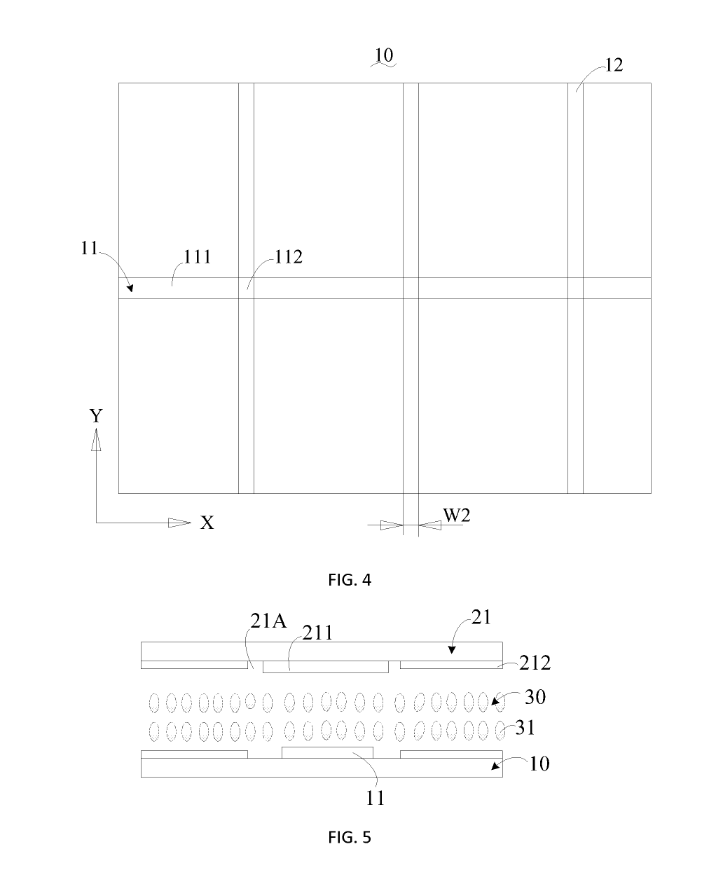

Referring to FIGS. 1 to 4, the liquid crystal panel includes an array substrate 10, a color filtering substrate 20 opposite to the array substrate 10, and a liquid crystal layer 30 between the array substrate 10 and the color filtering substrate 20.

The array substrate 10 includes a plurality of scanning lines 11 spaced apart from each other. It can be understood that only one scanning line 11 and a portion of the common electrode of the corresponding color filtering substrate 20 are shown in the drawings.

The color filtering substrate 20 includes a black matrix (BM) 201 and the common electrode 202. The scanning lines 11 correspond to the BM 201, and the common electrode 202 covers the BM 201. The common electrode 202 is a transparent electrode layer. The common electrode 202 includes a hollow structure 20A corresponding to the scanning line 11 so as to prevent the liquid crystal 31 in the hollow structure 20A from being twisted when the scanning voltage is applied to the scanning lines 11 and the public voltage is applied to the common electrode 202.

In one embodiment, the scanning lines 11 of the array substrate 10 extend along a first direction X. The scanning lines 11 are spaced apart from each other in a second V direction, and the second Y direction is vertical to the first direction X. In addition, the array substrate 10 also includes a plurality of data lines 12 intersecting with the scanning lines 11. The second scanning lines 12 extend along the second direction (Y) and the second scanning line 12 are spaced apart from each other in the first direction X.

The scanning line 11 includes a first area 111 and a second area 112. The first area 11 intersects with the data line 12, and the second area 112 has not interacted with the data line 12. In the embodiment, the hollow structure 20A corresponds to the second area 112 and the hollow structure 20A is arranged at two lateral sides of the BM 201. In other words, two lateral sides of the BM 201 are arranged with the hollow structure 20A. That is to say, the hollow structure 20A is arranged along the first direction X. The common electrode arranged at the location corresponding to the first area 111 separates the adjacent hollow structure 20A. to ensure different areas of the common electrode 202 are electrically connected. In brief, the hollow structures 20A are shown as discontinuous gaps.

In order to avoid the light leakage, the width of the hollow structure 20A in the first direction X is larger than or equal to the width of the second area 112 in the first direction X. In other words, the hollow structure 20A is arranged at two lateral sides of the BM, and is precisely corresponds to the second area 112 or precisely corresponds to the second area 112 together with a portion of the first area 111. Thus, the width (W1) of the location of the common electrode 202 corresponding to the first area 111 is not larger than the width (W2) of the data line 12 in the first direction X. it can be understood that the location of the common electrode 202 corresponding to the first area 111 relates to a connecting portion 202A of the common electrode 202. The width of the connecting portion 202A is W1. Also, the width (W2) of the data line 12 in the first direction X relates to the width of the data line 12.

Referring to FIG. 2, when the grayscale of the liquid crystal panel is zero, the scanning voltage applied by the scanning line 11 and the public voltage applied by the common electrode 202 are broken of in the hollow structure 20A such that the liquid crystal at the locations corresponding to the hollow structure 20A are not twisted. Thus, the light beams are unable to passthrough the above location of the liquid crystal layer 30. In this way, the group of light spots is avoided when the displacement occurs between the array substrate 10 and the color filtering substrate 20.

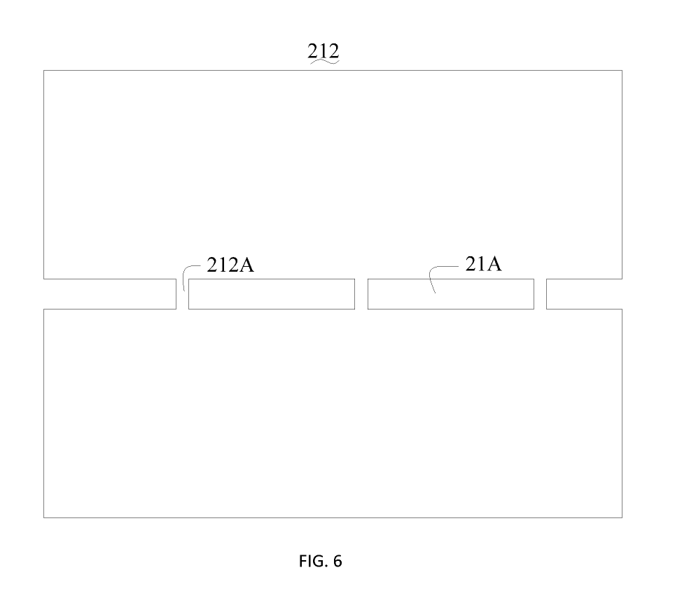

FIGS. 5 and 6 show the liquid crystal panel in accordance with a second embodiment. The liquid crystal panel includes the array substrate 10, the color filtering substrate 21, and the liquid crystal layer 30 between the array substrate 10 and the color filtering substrate 21.

In one embodiment, the color filtering substrate 21 includes the BM 211 and the common electrode 212. The common electrode 212 is arranged with the hollow structure 21A corresponding to the scanning line 11. The hollow structures 21A correspond to the second area 112 and the width of the hollow structure 21A is larger than that of the BM 211 such that the BM 211 is exposed via the hollow structure 21A. Thus, the BM 211 and the common electrode 212 are spaced apart by a certain gap.

In one embodiment, when the grayscale of the liquid crystal panel is zero, the hollow structure 20A of the common electrode 212 is above the scanning line 11. The electrical field is not formed between the first area 111 of the scanning line 11 and the common electrode 212 while the scanning voltage and the public voltage are applied. The liquid crystal located corresponding to the locations of the hollow structure 20A are prevented from being twisted so as to block the light beams to pass through and thus the group-like light spots are avoided.

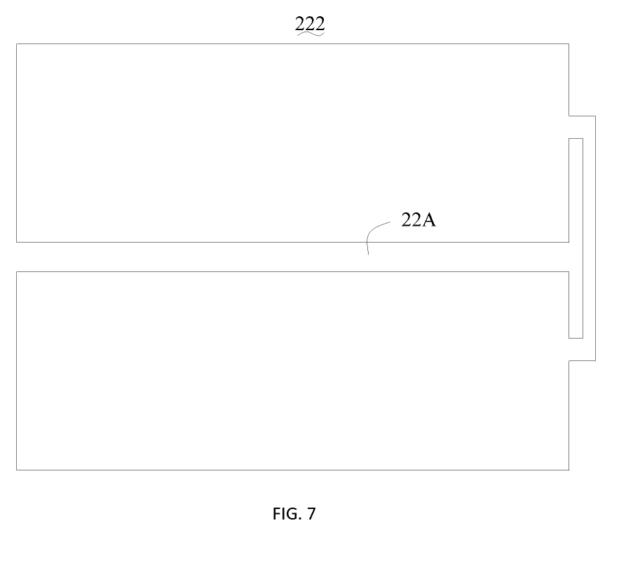

FIG. 7 is a schematic view of the common electrode of the color filtering substrate in accordance with a third embodiment. The common electrode 222 is also provided with consecutively arranged hollow structures 22A. In order to make sure the voltage of different areas of the common electrode 222 are the same, a connecting structure (not shown) is also arranged outside the common electrode 222. By adopting the hollow structure 22A, the liquid crystal located corresponding to the hollow structure 22A are prevented from being twisted so as to avoid the group-like light spots.

In one embodiment, a liquid crystal device includes the above liquid crystal panel.

Comparing to the conventional structure, the common electrode 202, 212, 222 of the liquid crystal panel of the claimed invention include the hollow structure 20A, 21A, 22A corresponding to the scanning line 11. As such, the liquid crystal 31 located corresponding to the hollow structures are prevented from being twisted when the scanning voltage and the public voltage are applied The hollow structures 20A, 21A, 22A downsize the twisted areas of the liquid crystal to avoid the light leakage resulting from the group-like light spots.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A liquid crystal panel, comprising:
an array substrate comprising a plurality of scanning lines spaced apart from each other, a plurality of data lines spaced apart from each other, and the data lines intersect with the scanning lines, the scanning line comprises a first area and a second area, and wherein the first area intersects with the data lines, and the second area has not interacted with the data lines;
a color filtering substrate opposite to the array substrate, and the color filtering substrate comprises a black matrix (BM) and a common electrode;
a liquid crystal layer between the array substrate and the color filtering substrate; and
wherein the scanning line is arranged corresponding to the BM, the common electrode covers the BM, the common electrode comprises a hollow structure corresponding to the second area of the scanning line such that liquid crystal located corresponding to the locations of the hollow structure in the liquid crystal layer are prevented from being twisted when the scanning line applies scanning voltage and the common electrode applies public voltage.

2. The liquid crystal panel as claimed in claim 1, wherein the scanning lines extend along a first direction and the data lines extend along a second direction, the second direction is vertical to the first direction, the scanning lines are spaced apart from each other in the second direction and the data lines are also spaced from each other in the first direction, and a width of the hollow structure in the first direction is larger than or equal to the width of the second area in the first direction.

3. The liquid crystal panel as claimed in claim 2, wherein the width of the location of the common electrode corresponding to the first area is not larger than the width of the data line in the first direction X.

4. The liquid crystal panel as claimed in claim 1, wherein the hollow structure is arranged at two lateral sides of the BM.

5. The liquid crystal panel as claimed in claim 1, wherein a width of the hollow structure is larger than that the width of the BM such that the BM is exposed via the hollow structure.

6. A liquid crystal panel, comprising:
an array substrate comprising a plurality of scanning lines spaced apart from each other;
a color filtering substrate opposite to the array substrate, and the color filtering substrate comprises a black matrix (BM) and a common electrode;
a liquid crystal layer between the array substrate and the color filtering substrate; and
wherein the scanning line is arranged corresponding to the BM, the common electrode covers the BM, the common electrode comprises a hollow structure such that liquid crystal located corresponding to the locations of the hollow structure in the liquid crystal layer are prevented from being twisted when the scanning line applies scanning voltage and the common electrode applies public voltage.

7. The liquid crystal panel as claimed in claim 6, the hollow structures are arranged along an extending direction of the scanning lines, and the hollow structures are spaced apart from each other.

8. The liquid crystal panel as claimed in claim 7, wherein the array substrate further comprises a plurality of data lines spaced apart from each other, the data lines intersect with the scanning line, the scanning line comprises a first area and a second area, and wherein the first area intersects with the data line, the second area has not interacted with the data line, and the hollow structure corresponds to the second area of the scanning line.

9. The liquid crystal panel as claimed in claim 8, wherein the scanning lines extend along a first direction and the data lines extend along a second direction, the second direction is vertical to the first direction, the scanning lines are spaced apart from each other in the second direction and the data lines are also spaced from each other in the first direction, and a width of the hollow structure in the first direction is larger than or equal to the width of the second area in the first direction.

10. The liquid crystal panel as claimed in claim 9, wherein the width of the location of the common electrode corresponding to the first area is not larger than the width of the data line in the first direction X.

11. The liquid crystal panel as claimed in claim 6, wherein the hollow structure is arranged at two lateral sides of the BM.

12. The liquid crystal panel as claimed in claim 6, wherein a width of the hollow structure is larger than that of the BM such that the BM is exposed via the hollow structure.

13. The liquid crystal panel as claimed in claim 6, wherein the hollow structures are consecutively arranged along an extending direction of the scanning line.

14. The liquid crystal panel as claimed in claim 6, wherein the common electrode is a transparent electrode layer.

15. A liquid crystal device, comprising:
an array substrate comprising a plurality of scanning lines spaced apart from each other;
a color filtering substrate opposite to the array substrate, and the color filtering substrate comprises a black matrix (BM) and a common electrode;
a liquid crystal layer between the array substrate and the color filtering substrate; and
wherein the scanning line is arranged corresponding to the BM, the common electrode covers the BM, the common electrode comprises a hollow structure such that liquid crystal located corresponding to the locations of the hollow structure in the liquid crystal layer are prevented from being twisted when the scanning line applies scanning voltage and the common electrode applies public voltage.

16. The liquid crystal device as claimed in claim 15, wherein the array substrate further comprises a plurality of data lines spaced apart from each other, the data lines intersect with the scanning line, the scanning line comprises a first area and a second area, and wherein the first area intersects with the data line, the second area has not interacted with the data line, and the hollow structure corresponds to the second area of the scanning line.

17. The liquid crystal device as claimed in claim 16, wherein the scanning lines extends along a first direction and the data lines extends along a second direction, the second direction is vertical to the first direction, the scanning lines are spaced apart from each other in the second direction and the data lines are also spaced from each other in the first direction, and a width of the hollow structure in the first direction is larger than or equal to the width of the second area in the first direction.

18. (canceled)

19. (canceled)

20. The liquid crystal device as claimed in claim 17, wherein the scanning lines extends along a first direction and the data lines extends along a second direction, the second direction is vertical to the first direction, the scanning lines are spaced apart from each other in the second direction and the data lines are also spaced from each other in the first direction, and a width of the hollow structure in the first direction is larger than or equal to the width of the second area in the first direction.

21. The liquid crystal panel as claimed in claim 14, wherein the hollow structure is arranged at two lateral sides of the BM.

22. The liquid crystal panel as claimed in claim 14, wherein a width of the hollow structure is larger than that of the BM such that the BM is exposed via the hollow structure.
